(19) United States
(12) Patent Application Publication
(10) Pub. No.: US 2017/0110801 A1
(43) Pub. Date: Apr. 20, 2017

(54) Radio-Frequency Transceiver System

(71) Applicant: Wistron NeWeb Corporation, Hsinchu (TW)

(72) Inventors: Cheng-Geng Jan, Hsinchu (TW); Chieh-Sheng Hsu, Hsinchu (TW)

(21) Appl. No.: 15/243,991

(22) Filed: Aug. 23, 2016

(30) Foreign Application Priority Data
Oct. 15, 2015 (TW) 104133795

(51) Int. Cl. H01Q 9/06; H01Q 21/24; H01Q 15/14; H01Q 1/24

(52) U.S. Cl. CPC H01Q 9/065; H01Q 1/243; H01Q 21/24; H01Q 15/14

(57) ABSTRACT

A radio-frequency transceiver system includes a first plane, a second plane perpendicular to the first plane, a third plane perpendicular to the first plane and the second plane, a first antenna element and a plurality of second antenna elements. The first antenna element includes a first radiation plate disposed on the first plane, a second radiation plate disposed on the first plane, a third radiation plate disposed on the second plane and a fourth radiation plate disposed on the second plane. The plurality of second antenna elements form an antenna array structure. The antenna array structure is symmetric with respect to the first plane and the second plane. Each of the second antenna elements is dual-polarized dipole antenna.

### BACKGROUND OF THE INVENTION

1. Field of the Invention

The present invention relates to a radio-frequency transceiver system, and more particularly, to a dual-polarized radio-frequency transceiver system with simple structure and compact size having higher gain and high bandwidth and supporting multiple frequency bands.

2. Description of the Prior Art

Electronic products with wireless communication functionalities utilize antennas to emit and receive radio waves, to transmit or exchange radio signals, so as to access a wireless communication network. With the advance of wireless communication technology, demand for transmission capacity and wireless network ability has grown dramatically in recent years. A long term evolution (LTE) wireless communication system support multi-input multi-output (MIMO) communication technology, which can vastly increase system throughput and transmission distance without increasing system bandwidth or total transmission power expenditure, thereby effectively enhancing spectral efficiency and transmission rate for the wireless communication system, as well as improving communication quality.

The long term evolution (LTE) wireless communication system includes 44 bands which cover from 698 MHz to 3800 MHz. Because of the different bands being separated and disordered, a mobile system operator may use multiple bands simultaneously in the same country or area. In such a condition, if multiple antennas are configured corresponding to different frequency bands, it is harmful to minimization of electronic products, and needs to utilize a multiplexer or a diplexer, thereby increasing additional power loss. Therefore, how to design antenna with simple structure and complying with transmission requirements while considering size and performance has been an issue in the industry.

### SUMMARY OF THE INVENTION

It is therefore an objective of the present invention to provide a radio-frequency transceiver system with simple structure and compact size having higher gain and supporting multiple frequency bands.

An aspect of the present invention is to provide a radio-frequency transceiver system, including a first plane, a second plane perpendicular to the first plane, a third plane perpendicular to the first plane and the second plane, a first antenna element, and a plurality of second antenna elements. The first antenna element includes a first radiation plate disposed on the first plane, a second radiation plate disposed on the first plane, a third radiation plate disposed on the second plane, and a fourth radiation plate disposed on the second plane. The second antenna elements form an antenna array structure, in which the antenna array structure is symmetric with respect to the first plane and the second plane, and each of the second antenna elements is dual-polarized dipole antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a radio-frequency transceiver system according to an embodiment of the present invention.

FIGS. 2A, 2B are schematic diagrams of radiation elements of the radio-frequency transceiver system shown in FIG. 1.

FIG. 3 is a schematic diagram illustrating antenna resonance simulation results of the radio-frequency transceiver system shown in FIG. 1.

FIG. 4 is a schematic diagram of a radio-frequency transceiver system according to an embodiment of the present invention.

FIG. 5 is a schematic diagram illustrating antenna resonance simulation results of the radio-frequency transceiver system shown in FIG. 4.

FIG. 6A is a schematic diagram of a radio-frequency transceiver system according to an embodiment of the present invention.

FIG. 6B is a schematic diagram of a top view of the radio-frequency transceiver system shown in FIG. 6A.

FIG. 6C is a schematic diagram of a cross section of the radio-frequency transceiver system along a cross line A-A′ shown in FIG. 6B.

FIG. 6D is a schematic diagram of a transmitting module TRM of the radio-frequency transceiver system shown in FIG. 6A.

FIG. 7 is a schematic diagram illustrating antenna resonance simulation results of the radio-frequency transceiver system shown in FIG. 6A operating in the low frequency band of Band 5, Band 12 and Band 29.

FIG. 8 is a schematic diagram illustrating antenna isolation simulation results of the radio-frequency transceiver system shown in FIG. 6A operating in the low frequency band of Band 5, Band 12 and Band 29.

FIG. 9 is a schematic diagram illustrating antenna resonance simulation results of the radio-frequency transceiver system shown in FIG. 6A operating in the high frequency band of Band 2, Band 4 and Band 30.

FIG. 10 is a schematic diagram illustrating antenna isolation simulation results of the radio-frequency transceiver system shown in FIG. 6A operating in the high frequency band of Band 2, Band 4 and Band 30.

FIG. 11 is a schematic diagram of a radio-frequency transceiver system according to an embodiment of the present invention.

FIGS. 12, 13 are schematic diagrams illustrating antenna resonance simulation results of the radio-frequency transceiver system shown in FIG. 11 operating in the low frequency band of Band 5, Band 12 and Band 29, and in the high frequency band of Band 2, Band 4 and Band 30, respectively.

### DETAILED DESCRIPTION

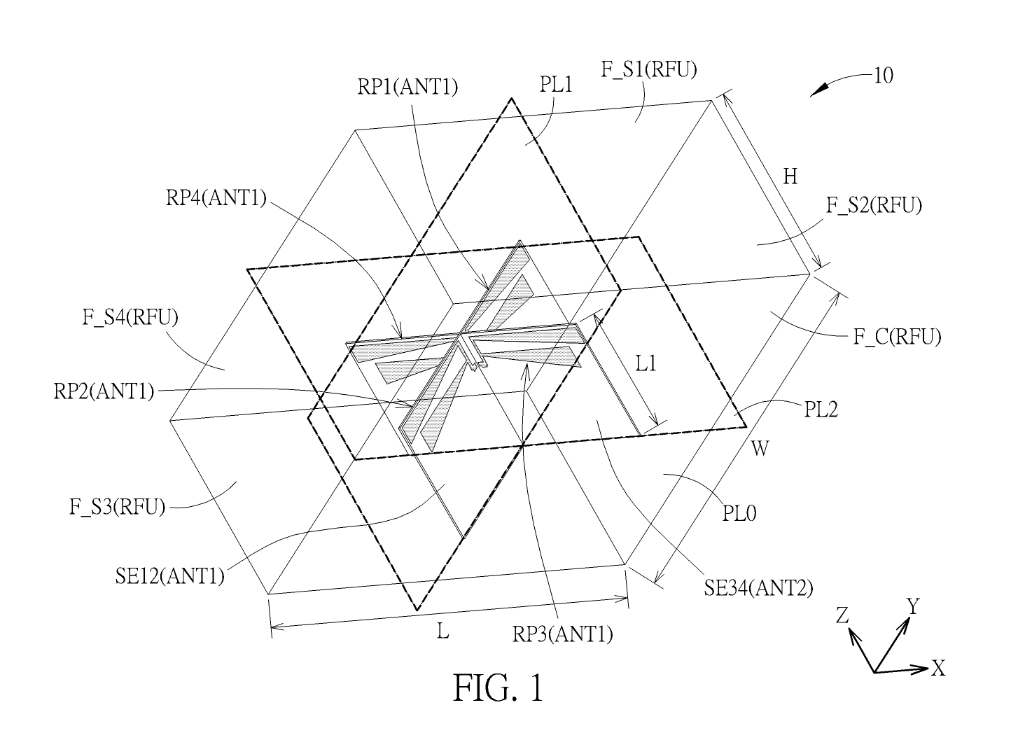

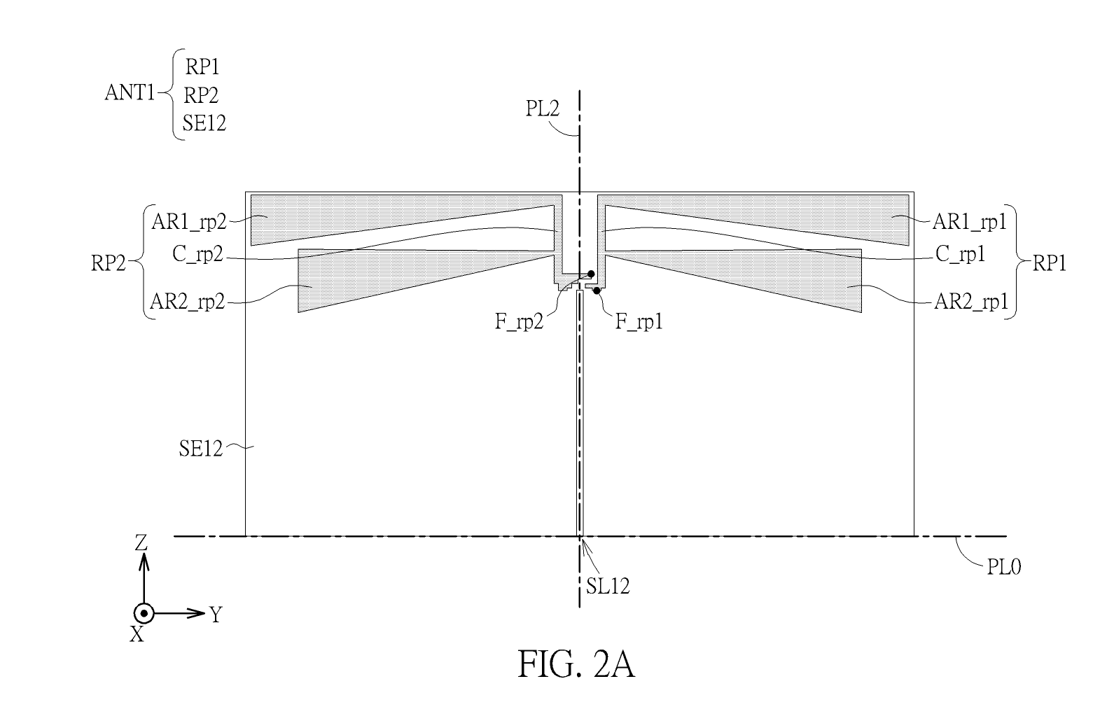

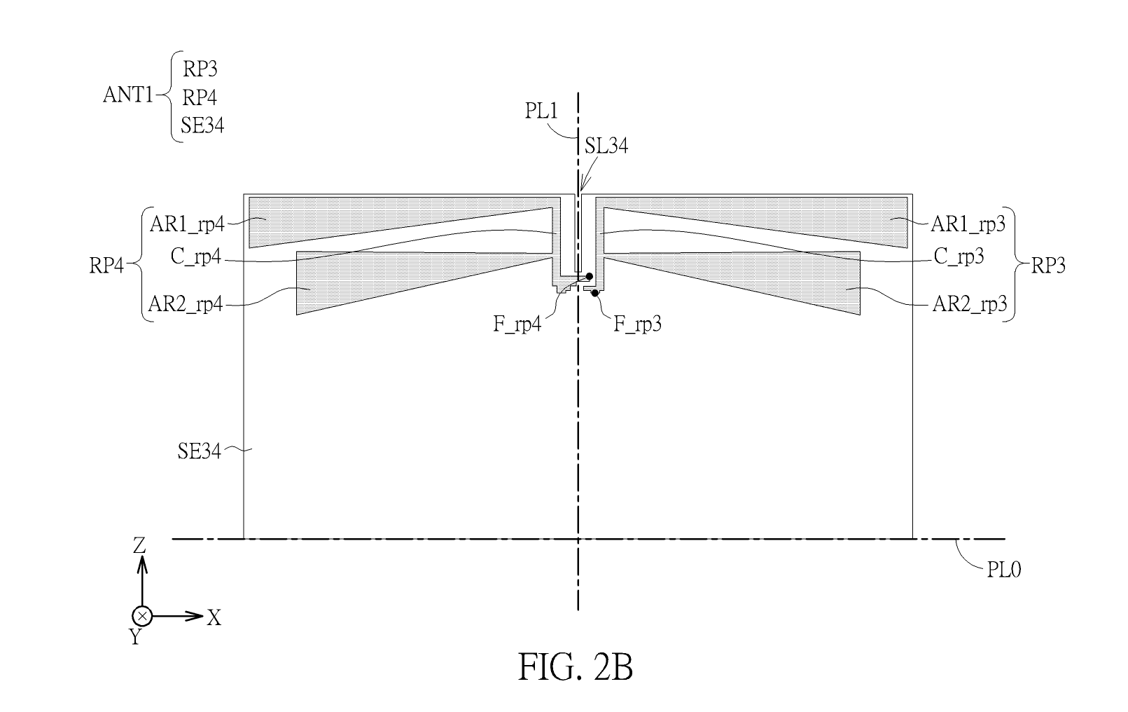

Please refer to FIGS. 1 to 2B. FIG. 1 is a schematic diagram of a radio-frequency transceiver system 10 according to an embodiment of the present invention. FIGS. 2A, 2B are schematic diagrams of radiation elements of the radio-frequency transceiver system 10. The radio-frequency transceiver system 10 includes a first antenna element ANT1 and a reflective unit RFU, and are utilized for receiving and transmitting radio signals of broadband or multiple frequency bands, e.g. signals of Band 5 (its frequency band is substantially between 824-849 MHz and 869-894 MHz) Band 12 (its frequency band is substantially between 698-716 MHz and 728-746 MHz) and Band 29 (its frequency band is substantially between 717 MHz-728 MHz) of long term evolution wireless communication system. The reflective unit RFU includes a central reflective element F_C and peripheral reflective elements F_S1-F_S4. The central reflective element F_C is disposed on a plane PL0 (i.e. x-y plane), the peripheral reflective elements F_S1-F_S4 are disposed around the central reflective element F_C to forma symmetric structure with respect to a plane PL1 (i.e. y-z plane), and a plane PL2 (i.e. x-z plane). The reflective unit RFU is symmetric with respect to the plane PL1 and the plane PL2. The first antenna element ANT1 includes radiation plates RP1-RP4 and substrates SE12, SE34, in which the radiation plates RP1, RP2 are disposed on a same surface of the substrate SE12 and form a first two arm bowtie dipole antenna, and the radiation plates RP3, RP4 are disposed on a same surface of the substrate SE34 and form a second two arm bowtie dipole antenna. The substrates SE12, SE34 are located in the plane PL1, PL2, respectively, and are perpendicular to each other, i.e. the radiation plate RP1 (or the radiation plate RP2) is perpendicular to the radiation plates RP3, RP4, and the radiation plate RP3 (or the radiation plate RP4) is perpendicular to the radiation plates RP1, RP2, such that a orthogonal dual-polarized dipole antenna is formed.

Moreover, the radiation plates RP1-RP4 include the first radiation arms AR1_rp1-AR1_rp4, the second radiation arms AR2_rp1-AR2_rp4 and strip connection parts C_rp1-C_rp4, respectively, to form two arm bowtie dipole antenna structures of 8-9% bandwidth, respectively. The first radiation arms AR1_rp1, AR1_rp2 and the second radiation arms AR2_rp1, AR2_rp2 are symmetric with respect to the plane PL2, and the first radiation arms AR1_rp3, AR1_rp4 and the second radiation arms AR2_rp3, AR2_rp4 are symmetric with respect to the plane PL1, i.e. the first antenna element ANT1 is disposed in the center of the reflective unit RFU. Because of a length difference between the first radiation arms AR1_rp1-AR1_rp4 and the second radiation arms AR2_rp1-AR2_rp4, the longer first radiation arms AR1_rp1-AR1_rp4 can receive and transmit radio signals with lower frequency, and the shorter second radiation arms AR2_rp1-AR2_rp4 can receive and transmit radio signals with higher frequency. The second radiation arms AR2_rp1-AR2_rp4 are disposed between the first radiation arms AR1_rp1-AR1_rp4 and the central reflective element F_C, respectively, and thus having a shorter distance from the central reflective element F_C. The connection parts C_rp1-C_rp4 are connected between the first radiation arms AR1_rp1-AR1_rp4 and the second radiation arms AR2_rp1-AR2_rp4 and includes the feed-in points F_rp1-F_rp4. As a result, power can be fed in from the feed-in points F_rp1-F_rp4 of the connection parts C_rp1-C_rp4, and then transferred to the second radiation arms AR2_rp1-AR2_rp4 and the first radiation arms AR1_rp1-AR1_rp4 sequentially. In consideration of welding feed-in wires during the assembly process, the feed-in points F_rp1 and F_rp2 are disposed on a same side of the plane PL2, and the feed-in points F_rp3 and F_rp4 are disposed on a same side of the plane PL1. Besides, in order to prevent connection wires of the feed-in points F_rp2 and F_rp4 crossing the center from being cut off during printed circuit board (PCB) processes, the connection wires crossing the center and the feed-in points F_rp1-F_rp4 can have different heights with respect to the central reflective element F_C, shapes of the connection parts C_rp1-C_rp4 can be slightly different, and slots SL12, SL34 can be formed on the substrate SE12, SE34, which are not limited to these.

In short, the requirements of frequency bands of Band 5, Band 12 and Band 29 of the long term evolution wireless communication system can be satisfied by a dual-polarized dipole antenna that includes the radiation plates RP1-RP4 of the first antenna element ANT1 disposed on the planes PL1 and PL2.

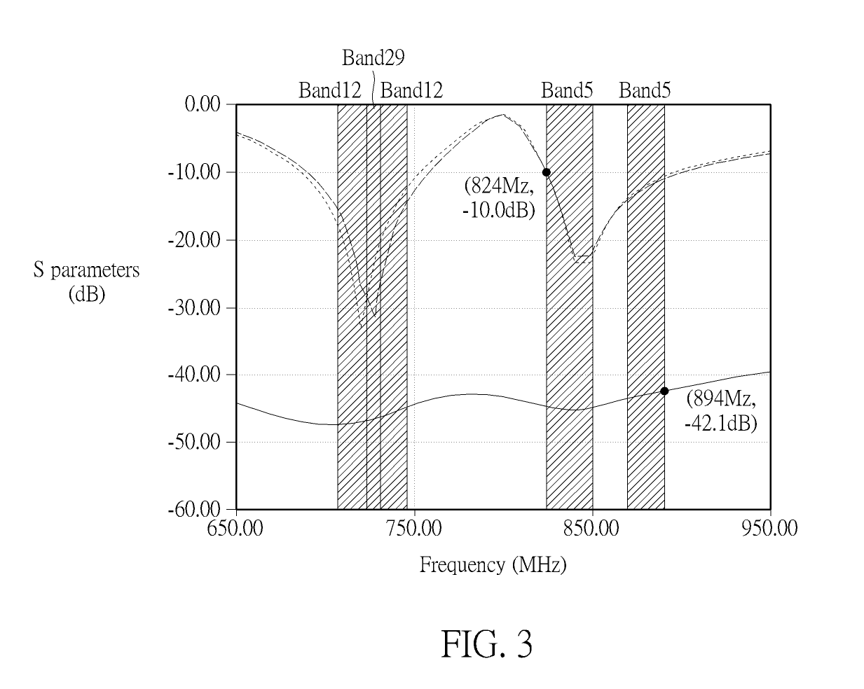

Simulation and measurement may be employed to determine whether resonant characteristics of the radio-frequency transceiver system 10 meet the system requirements. Please refer to FIG. 3 and table 1, in which a length L and a width W of the radio-frequency transceiver system 10 are set to 300 mm, a height H is set to 70 mm, and a longest distance L1 from the first antenna element ANT1 to the central reflective element F_C is set to 99 mm. FIG. 3 is a schematic diagram illustrating antenna resonance simulation results of the radio-frequency transceiver system 10, in which the antenna resonance simulation results for the first two arm bowtie dipole antenna formed by the radiation plates RP1, RP2 are represented by the long dashed line, the antenna resonance simulation results for the second two arm bowtie dipole antenna formed by the radiation plates RP3, RP4 are represented by a short dashed line, and the antenna isolation simulation results between the first two arm bowtie dipole antenna and the second two arm bowtie dipole antenna are represented by the solid line. According to FIG. 3, within the frequency bands of Band 5, Band 12 and Band 29, the return loss (i.e., S11 value) of the radio-frequency transceiver system 10 is larger than 10.0 dB, and isolation is greater than 42.1 dB, which meet the LTE wireless communication system requirements of having the return loss larger than 10 dB and the isolation greater than 20 dB. Table 1 is an antenna characteristics table of the first two arm bowtie dipole antenna and the second two arm bowtie dipole antenna of the radio-frequency transceiver system 10 corresponding to different frequencies. As shown in table 1, a maximum gain of the radio-frequency transceiver system 10 operating in Band 12 and Band 29 is 7.99-8.43 dBi, and a maximum gain of the radio-frequency transceiver system 10 operating in Band 5 is 8.18-9.16 dBi. As a result, the radio-frequency transceiver system 10 of the present invention meets LTE wireless communication system requirements of Band 12 and Band 29 (whose maximum gain should be greater than 6 dBi) and Band 5 (whose maximum gain should be greater than 7 dBi).

TABLE 1

| | | | | 3 dB |
|---|---|---|---|---|
| | maximum | 3 dB | maximum gain | beamwidth |
| | gain | beamwidth of | of second | of |
| | of first two | first two | two arm | second two |
| | arm bowtie | arm bowtie | bowtie | arm bowtie |
| | dipole | dipole | dipole | dipole |
| frequency | antenna | antenna | antenna | antenna |
| (MHz) | (dBi) | (degree) | (dBi) | (degree) |
| 698 | 7.99 | 78 | 8.11 | 70 |
| 716 | 8.32 | 78 | 8.39 | 69 |
| 728 | 8.41 | 77 | 8.43 | 69 |
| 746 | 8.29 | 76 | 8.22 | 68 |
| 824 | 8.21 | 70 | 8.18 | 62 |
| 849 | 9.11 | 70 | 9.16 | 61 |
| 869 | 9.12 | 69 | 9.16 | 60 |
| 894 | 9.04 | 68 | 9.05 | 59 |

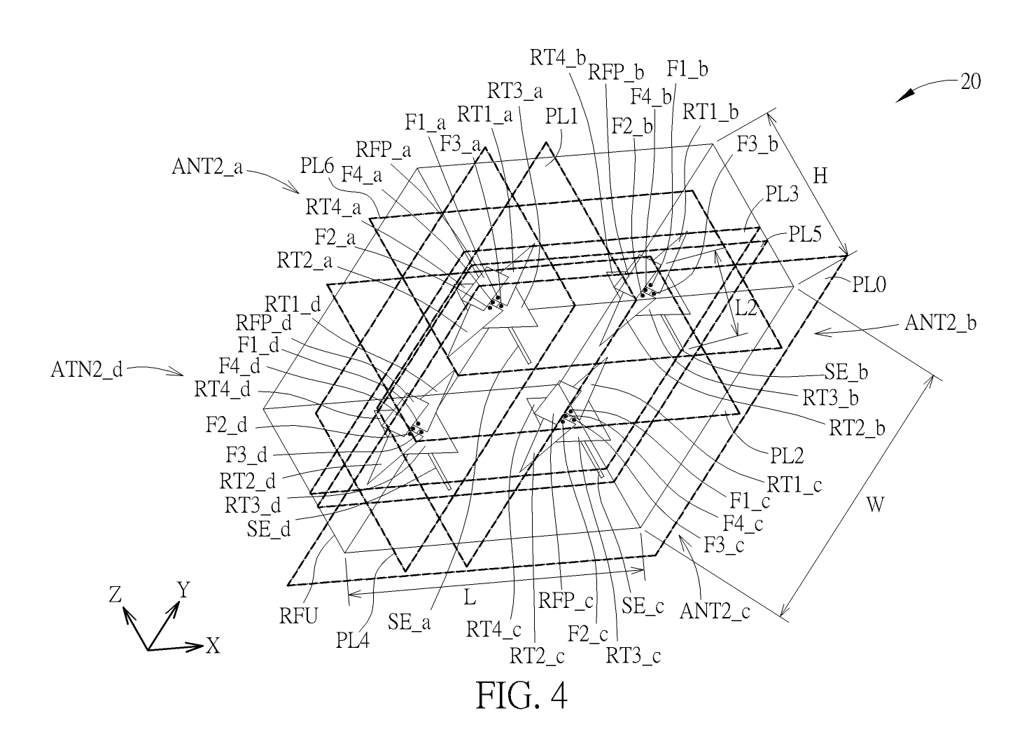

Please refer to FIG. 4, which is a schematic diagram of a radio-frequency transceiver system 20 according to an embodiment of the present invention. The radio-frequency transceiver system 20 includes the reflective unit RFU and second antenna elements ANT2_a-ANT2_d, and are utilized for receiving and transmitting radio signals of broadband or multiple frequency bands, e.g. signals of Band 2 (its frequency band is substantially between 1.85-1.91 GHz and 1.93-1.99 GHz), Band 4 (its frequency band is substantially between 1.71-1.755 GHz and 2.11-2.155 GHz) and Band 30 (its frequency band is substantially between 2.305-2.315 GHz and 2.35-2.36 GHz) of long term evolution wireless communication system. The second antenna elements ANT2_a-ANT2_d are antenna units with the same structure and size, so as to form an antenna array structure capable of increasing maximum gain, in which the antenna array structure is symmetric with respect to the plane PL1 (i.e. y-z plane) and the plane PL2 (i.e. x-z plane). The second antenna elements ANT2_a-ANT2_d include reflective plates RFP_a-RFP_d, radiators RT1_a-RT4_d and supporting elements SE_a-SE_d, respectively. The radiators RT1_a-RT4_d form a triangle, and include feed-in points F1_a-F4_d, respectively. For simplicity, only the second antenna element ANT2_a will be illustrated in the following example. A first diamond dipole antenna (array) with 45% bandwidth may be formed by having the supporting element SE_a, the radiators RT1_a and RT2_a disposed on a plane PL3 implemented, in which the radiators RT1_a, RT2_ are symmetric with respect to planes PL4 and PL6. Similarly, the radiators RT3_a, RT4_a are substantially disposed on a plane PL5 and are symmetric with respect to the planes PL4, PL6, to form a second diamond dipole antenna (array) with 45% bandwidth. The planes PL3, PL5 are parallel to a plane PL0 (i.e. x-y plane), and the plane PL5 is disposed between the planes PL0, PL3. Since the planes PL4, PL6 are perpendicular to each other, the first diamond dipole antenna (array) and the second diamond dipole antenna (array) form an orthogonal dual-polarized dipole antenna. Besides, the reflective plate RFP_a is parallel to the plane PL0, disposed above the radiators RT1_a-RT4_d, and utilized for increasing effective radiation area, making maximum gains corresponding to frequency band of Band 2, Band 4 and Band 30 increase as frequency increases. A shape of the reflective plate RFP_a is symmetric with respect to the planes PL4, PL6, and can be a circle or a regular polygon with a number of vertexes to be a multiple of 4.

In short, the requirements of frequency bands of Band 2, Band 4 and Band 30 of the long term evolution wireless communication system can be satisfied by a dual-polarized dipole antenna that includes the radiators RT1_a-RT4_d of the second antenna elements ANT2_a-ANT2_d disposed on the planes PL3 and PL5.

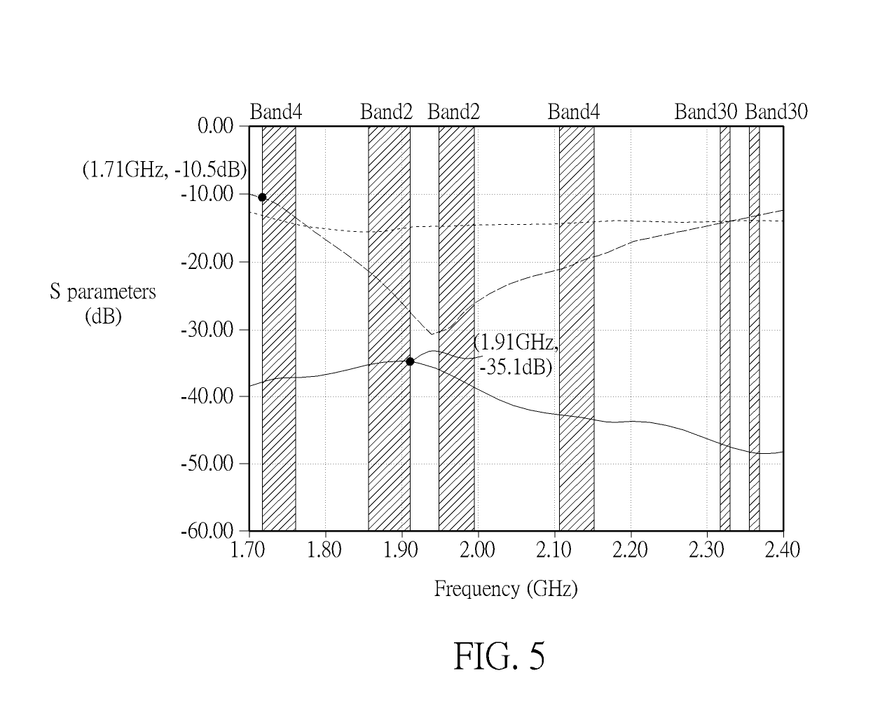

Simulation and measurement may be employed to determine whether resonant characteristics and radiation pattern of the radio-frequency transceiver system 20 meets system requirements. Please refer to FIG. 5 and table 2, in which a length L and a width W of the radio-frequency transceiver system 20 are set to 300 mm, a height H is set to 50 mm, and a longest distance L2 from the second antenna elements ANT2_a-ANT2_d to the central reflective element F_C is set to 42 mm. FIG. 5 is a schematic diagram illustrating antenna resonance simulation results of the radio-frequency transceiver system 20, in which the antenna resonance simulation results for the first diamond dipole antenna (array) formed by the radiation plates RT1_a-RT1_d, RT2_a-RT2_d are represented by the long dashed line, the antenna resonance simulation results for the second diamond dipole antenna (array) formed by the radiation plates RT3_a-RT3_d, RT4_a-RT4_d are represented by the short dashed line, and the antenna isolation simulation results between the first diamond dipole antenna (array) and the second diamond dipole antenna (array) is represented by the solid line. According to FIG. 5, within frequency bands of Band 2, Band 4 and Band 30, the return loss (i.e., S11 value) of the radio-frequency transceiver system 20 is larger than 10.5 dB, and isolation is greater than 35.1 dB. Table 2 is an antenna characteristics table of the first diamond dipole antenna (array) and the second diamond dipole antenna (array) of the radio-frequency transceiver system 20 corresponding to different frequencies. As shown in table 2, a maximum gain of the radio-frequency transceiver system 20 operating in Band 2 and Band 4 is 14.5-16.9 dBi, and operating a maximum gain of the radio-frequency transceiver system 20 operating in Band 30 is 16.8-17.0 dBi. As a result, the radio-frequency transceiver system 20 of the present invention meets LTE wireless communication system requirements of Band 2 and Band 4 (whose maximum gain should be greater than 12 dBi) and Band 30 (whose maximum gain should be greater than 13 dBi).

TABLE 2

| | maximum | 3 dB | | 3 dB |
|---|---|---|---|---|
| | gain | beamwidth of | maximum gain | beamwidth of |
| | of first | first | of second | second |
| | diamond | diamond | diamond | diamond |
| | dipole | dipole | dipole | dipole |
| | antenna | antenna | antenna | antenna |
| frequency | array | array | array | array |
| (MHz) | (dBi) | (degree) | (dBi) | (degree) |
| 1710 | 14.5 | 32 | 14.8 | 32 |
| 1755 | 14.9 | 31 | 15.1 | 32 |
| 1850 | 15.6 | 28 | 15.7 | 30 |
| 1910 | 16.0 | 26 | 16.0 | 29 |
| 1930 | 16.1 | 26 | 16.1 | 28 |
| 1990 | 16.5 | 24 | 16.5 | 27 |
| 2110 | 16.9 | 23 | 16.8 | 26 |
| 2155 | 16.8 | 22 | 16.7 | 25 |
| 2305 | 16.8 | 21 | 16.9 | 23 |
| 2315 | 16.8 | 21 | 16.9 | 23 |
| 2350 | 16.9 | 21 | 17.0 | 23 |
| 2360 | 16.9 | 21 | 17.0 | 23 |

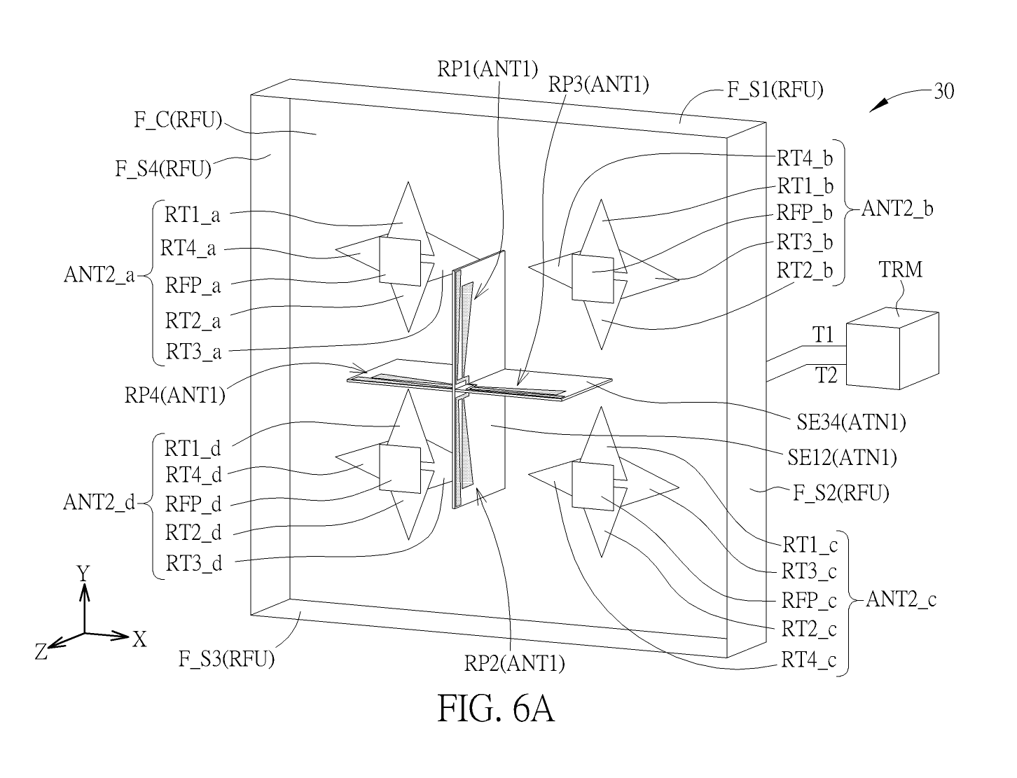

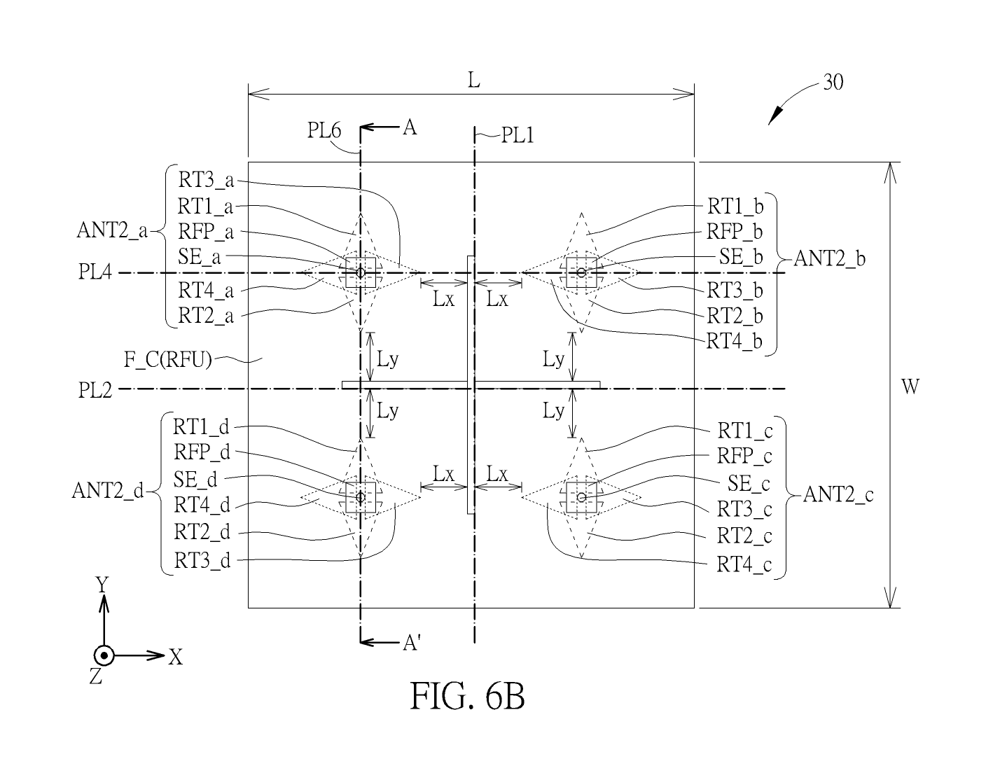

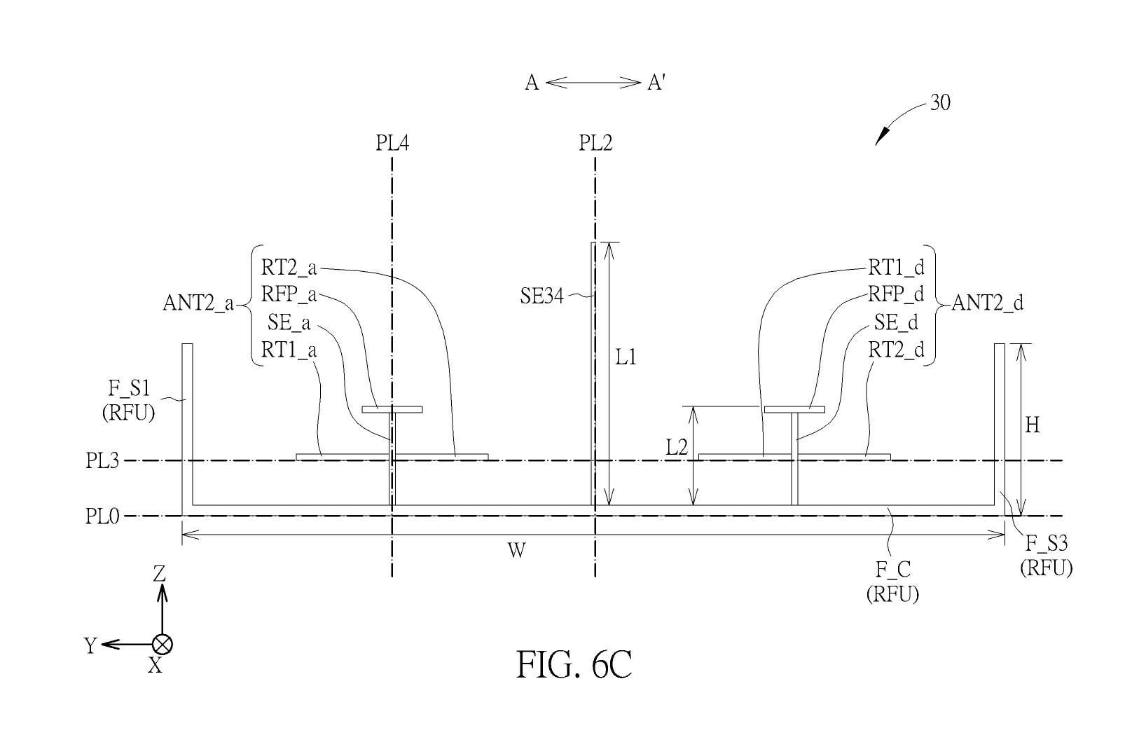

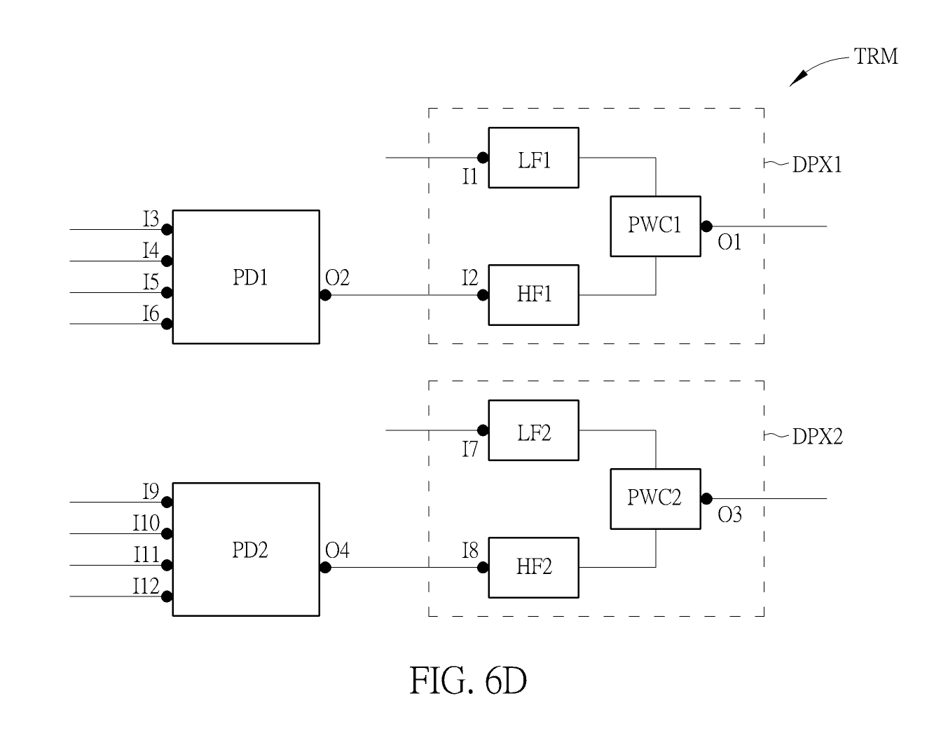

Please refer to FIGS. 6A to 6D. FIG. 6A is a schematic diagram of a radio-frequency transceiver system 30 according to an embodiment of the present invention, FIG. 6B is a schematic diagram of a top view of the radio-frequency transceiver system 30, FIG. 6C is a schematic diagram of a cross section of the radio-frequency transceiver system 30 along a cross line A-A′ shown in FIG. 6B, FIG. 6D is a schematic diagram of a transmitting module TRM of the radio-frequency transceiver system 30. The radio-frequency transceiver system 30 includes the reflective unit RFU, the first antenna element ANT1, the second antenna elements ANT2_a-ANT2_d and a transmitting module TRM, to receive and transmit signals of broadband or multiple frequency bands, e.g. radio signals of low frequency band of Band 5, Band 12 and Band 29 and radio signals of high frequency bands of Band 2, Band 4 and Band 30. The reflective unit RFU and the first antenna element ANT1 and the second antenna elements ANT2_a-ANT2_d are illustrated in FIGS. 1 to 2B and FIG. 4, respectively, and thus the same elements are denoted by the same symbols, and are not narrated hereinafter. As shown in FIG. 6B, the radio-frequency transceiver system 30 is symmetric with respect to the plane PL1 (i.e. y-z plane) and the plane PL2 (i.e. x-z plane), but a distance Lx along x direction and a distance Ly along y direction between the first antenna element ANT1 and the second antenna elements (e.g. the second antenna elements ANT2_a) may be different. The first two arm bowtie dipole antenna formed by the radiation plates RP1, RP2 of the first antenna element ANT1 and the first diamond dipole antenna (array) formed by the radiation plates RT1_a-RT1_d, RT2_a-RT2_d of the second antenna elements ANT2_a-ANT2_d are both vertically polarized. The second two arm bowtie dipole antenna formed by the radiation plates RP3, RP4 of the first antenna element ANT1 and the second diamond dipole antenna (array) formed by the radiation plates RT3_a-RT3_d, RT4_a-RT4_d of the second antenna elements ANT2_a-ANT2_d horizontally polarized. Therefore, two independent channels can be provided to receive and transmit radio signals. Besides, the radiation plates RP1-RP4 of the first antenna element ANT1 are disposed on the planes PL1, PL2, the radiators RT1_a-RT4_d of the second antenna elements ANT2_a-ANT2_d are disposed on the planes PL3, PL5 parallel to each other, and the planes PL1, PL2, PL3 (or PL5) are perpendicular to each other, such that the first antenna element ANT1 extends along the vertical direction (i.e. z-direction) and the second antenna elements ANT2_a-ANT2_d extend along the horizontal direction (i.e. on x-y plane), thereby preventing the first antenna element ANT1 and the second antenna elements ANT2_a-ANT2_d from interfering with each other in the space. Therefore, the space can be fully utilized to minimize the size.

Besides, the transmitting module TRM includes four-in-one-out power dividers PD1, PD2 and diplexers DPX1, DPX2. The diplexers DPX1, DPX2 includes low pass filters LF1, LF2, high pass filters HF1, HF2 and power combiners PWC1, PWC2, respectively, and integrate radio signals received and transmitted by the first antenna element ANT1 in low frequency bands of Band 5, Band 12 and Band 29 and radio signals received and transmitted by the second antenna elements ANT2_a-ANT2_d in high frequency band of Band 2, Band 4 and Band 30. Corresponding to vertical polarization, an input terminal I1 of the diplexer DPX1 is coupled to the feed-in points F_rp1, F_rp2 of the first antenna element ANT1, and an input terminal I2 of the diplexer DPX1 is connected to an output terminal O2 of the four-in-one-out power divider PD1 first and then coupled to the feed-in points F1_a-F1_d, F2_a-F2_d of the second antenna elements ANT2_a-ANT2_d via input terminals I3-I6 of the four-in-one-out power divider PD1, respectively. When radio signals are transmitted from the input terminal I1 to the low pass filter LF1, only radio signals in the low frequency band can be passed, and radio signals in the high frequency band are reflected because return loss of the low pass filter LF1 is above 30 dB; Similarly, when radio signals are transmitted from the input terminal I2 to the high pass filter HF1, only radio signals in the high frequency band can be passed, and radio signals in the low frequency band are reflected because return loss of the high pass filter HF1 is above 30 dB. As a result, the low pass filter LF1 and the high pass filter HF1 transmit radio signals in low frequency band and high frequency band to the output terminal O1 via the power combiner PWC1, respectively. On the other hand, when radio signals are transmitted from the output terminal O1 to the diplexer DPX1, since return loss of the low pass filter LF1 corresponding to the high frequency band and return loss of the high pass filter HF1 corresponding to the low frequency band are at least 30 dB, radio signals of the low frequency band are transferred to the input terminal I1 and radiates outward via the first antenna element ANT1, and radio signal of the high frequency band are transferred to the input terminal I2 and radiate outward via the second antenna elements ANT2_a-ANT2_d. Similarly, corresponding to horizontal polarization, an input terminal I7 of the diplexer DPX2 is coupled to the feed-in point F_rp3, F_rp4 of the first antenna element ANT1, and an input terminal I8 of the diplexer DPX2 is connected to and output terminal O4 of the four-in-one-out power divider PD2 first and then coupled to the feed-in points F3_a-F3_d, F4_a-F4_d of the second antenna elements ANT2_a-ANT2_d via input terminals I9-I12 of the four-in-one-out power divider PD2, respectively. Besides, the low pass filter LF2 and the high pass filter HF2 transmit radio signals in the low frequency band and the high frequency band to an output terminal O3 via the power combiner PWC2, respectively; otherwise, radio signals of the low frequency band are transferred to the input terminal I7 and radiate ANT1 outward via the first antenna element, and radio signals of the high frequency band are transferred to the input terminal I8 and radiate outward via the second antenna elements ANT2_a-ANT2_d.

In short, other than the diplexers DPX1, DPX2, no additional diplexers or multiplexers are needed, thereby avoiding energy loss. Besides, the first antenna element ANT1 and the second antenna elements ANT2_a-ANT2_d of the radio-frequency transceiver system 30 provide two independent antenna transmission and reception channels to receive and transmit radio signals of multiple frequency bands. Furthermore, since the planes of which the first antenna element ANT1 and the second antenna elements ANT2_a-ANT2_d are disposed on are perpendicular to each other, the first antenna element ANT1 extends along the vertical direction (i.e. z-direction), and the second antenna elements ANT2_a-ANT2_d extend along the horizontal direction (i.e. on x-y plane), thereby preventing the first antenna element ANT1 and the second antenna elements ANT2_a-ANT2_d from interfering with each other in the space. Therefore, the space can be fully utilized to minimize the size.

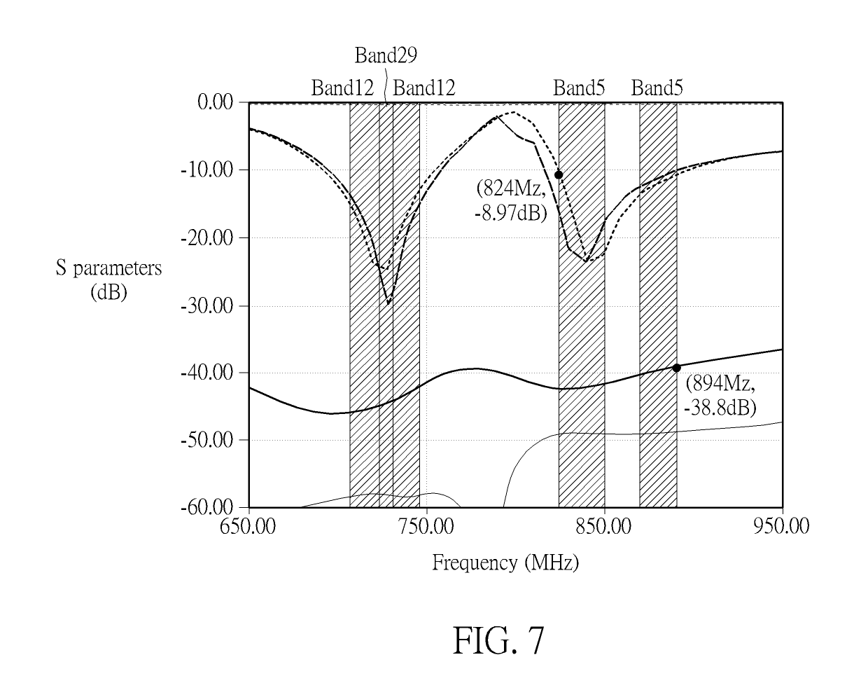

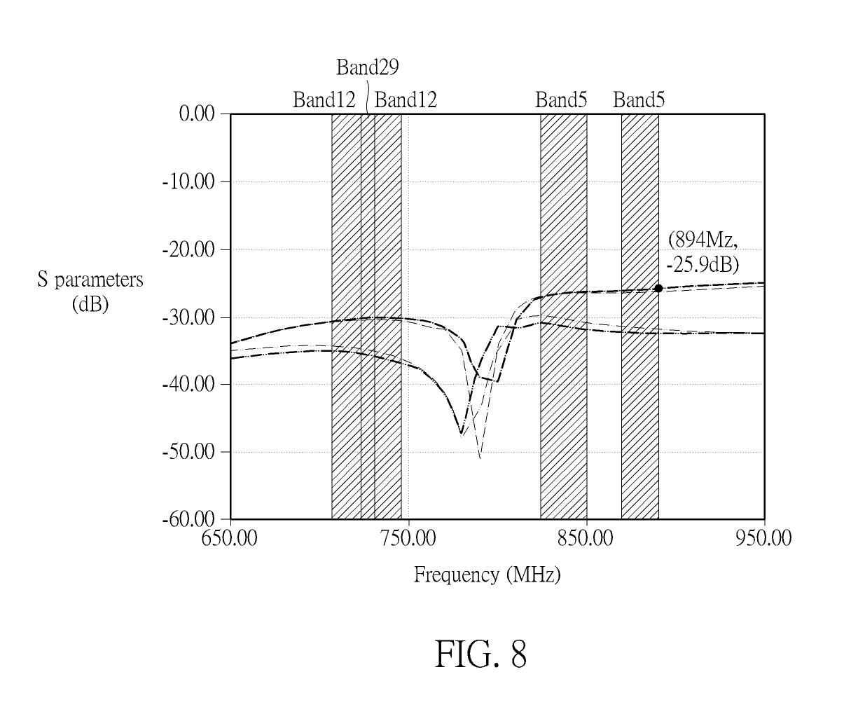

Simulation and measurement may be employed to determine whether resonant characteristics of the radio-frequency transceiver system 30 meet the system requirements. For Band 5, Band 12 and Band 29 of the low frequency band, please refer to FIGS. 7, 8, table 3 and table 4, in which a length L and a width W of the radio-frequency transceiver system 30 are set to 300 mm, a height H is set to 50 mm, a longest distance L1 from the first antenna element ANT1 to the central reflective element F_C is set to 99 mm, and a longest distance L2 from the second antenna elements ANT2_a-ANT2_d to the central reflective element F_C is set to 42 mm. FIG. 7 is a schematic diagram illustrating antenna resonance simulation results of the radio-frequency transceiver system 30 operating in the low frequency band of Band 5, Band 12 and Band 29. The antenna resonance simulation result of the first two arm bowtie dipole antenna of the first antenna element ANT1 are represented by the thick long dashed line, the antenna resonance simulation result of the second two arm bowtie dipole antenna of the first antenna element ANT1 are represented by the thick short dashed line, and the antenna isolation simulation result illustrating the isolation between the first two arm bowtie dipole antenna and the second two arm bowtie dipole antenna of the first antenna element ANT1 is represented by the thick solid line. Besides, antenna resonance simulation results for the first diamond dipole antenna (array) of the second antenna elements ANT2_a-ANT2_d are represented by the thin long dashed line, the antenna resonance simulation results for the second diamond dipole antenna (array) of the second antenna elements ANT2_a-ANT2_d are represented by the thin short dashed line, and the antenna isolation simulation result illustrating the isolation between the first diamond dipole antenna (array) and the second diamond dipole antenna (array) of the second antenna elements ANT2_a-ANT2_d is represented by a thin solid line. According to FIG. 7, within frequency bands of Band 5, Band 12 and Band 29, the return loss (i.e., S11 value) of the first antenna element ANT1 is larger than 9.87 dB, and the isolation is greater than 38.8 dB; in comparison, the return loss of the antenna array of the second antenna elements ANT2_a-ANT2_d is substantially 0.0 dB, i.e. energy is almost entirely reflected.

FIG. 8 is a schematic diagram illustrating antenna isolation simulation results of the radio-frequency transceiver system 30 operating in the low frequency band of Band 5, Band 12 and Band 29, in which antenna isolation simulation result illustrating the isolation between the first two arm bowtie dipole antenna of the first antenna element ANT1 and the first diamond dipole antenna (array) of the second antenna elements ANT2_a-ANT2_d are represented by the thin dash-dot line, the antenna isolation simulation result between the second two arm bowtie dipole antenna of the first antenna element ANT1 and the second diamond dipole antenna (array) of the second antenna elements ANT2_a-ANT2_d are represented by the thick dash-dot line, the antenna isolation simulation result illustrating the isolation between the second two arm bowtie dipole antenna of the first antenna element ANT1 and the first diamond dipole antenna (array) of the second antenna elements ANT2_a-ANT2_d are represented by the thin dash-dot-dot line, and the antenna isolation simulation result illustrating the isolation between the first two arm bowtie dipole antenna of the first antenna element ANT1 and the second diamond dipole antenna (array) of the second antenna elements ANT2_a-ANT2_d are represented by the thick dash-dot-dot line. According to FIG. 8, within low frequency bands of Band 5, Band 12 and Band 29, antenna isolation between the first antenna element ANT1 and the antenna array of the second antenna elements ANT2_a-ANT2_d is at least 25.9 dB. Therefore, power of the first antenna element ANT1 in the low frequency band coupled to the antenna array of the second antenna elements ANT2_a-ANT2_d is about −25.9 dB at most. Table 3 is an antenna characteristics table of the first antenna element ANT1 of the radio-frequency transceiver system 30 corresponding to different frequencies in the low frequency band of Band 5, Band 12 and Band 29. Table 4 is an antenna characteristics table of the antenna array of the second antenna elements ANT2_a-ANT2_d of the radio-frequency transceiver system 30 corresponding to different frequencies in the low frequency band of Band 5, Band 12 and Band 29. As shown in table 3, a maximum gain of the first antenna element ANT1 operating in Band 12 and Band 29 is 7.90-8.37 dBi, and a maximum gain of the first antenna element ANT1 operating in Band 5 is 8.12-9.00 dBi. (following is illustrated as 9 dBi), so as to meet LTE wireless communication system requirements for Band 12 and Band 29 (whose maximum gain should be greater than 6 dBi) and Band 5 (whose maximum gain should be greater than 7 dBi); as shown in table 4, in comparison, although the antenna array of the second antenna elements ANT2_a-ANT2_d is utilized for receiving and transmitting radio signals in the high frequency band, undesired resonance is generated in the low frequency band, in which the antenna array of the second antenna elements ANT2_a-ANT2_d most likely generates undesired resonance when operating in 824 MHz, and its maximum gain is about −7.52 dBi (following is illustrated as −7 dBi).

TABLE 3

| | | | | 3 dB |
|---|---|---|---|---|
| | maximum | 3 dB | maximum gain | beamwidth |
| | gain | beamwidth of | of second | of |
| | of first two | first two | two arm | second two |
| | arm bowtie | arm bowtie | bowtie | arm bowtie |
| | dipole | dipole | dipole | dipole |
| frequency | antenna | antenna | antenna | antenna |
| (MHz) | (dBi) | (degree) | (dBi) | (degree) |
| 698 | 7.90 | 80 | 7.93 | 68 |
| 716 | 8.28 | 80 | 8.27 | 68 |
| 728 | 8.37 | 79 | 8.34 | 67 |
| 746 | 8.21 | 79 | 8.15 | 67 |
| 824 | 8.64 | 72 | 8.12 | 62 |
| 849 | 9.00 | 72 | 9.00 | 61 |
| 869 | 8.93 | 72 | 8.97 | 61 |
| 894 | 8.80 | 71 | 8.83 | 60 |

TABLE 4

| | maximum | 3 dB | | 3 dB |
|---|---|---|---|---|
| | gain | beamwidth of | maximum gain | beamwidth of |
| | of first | first | of second | second |
| | diamond | diamond | diamond | diamond |
| | dipole | dipole | dipole | dipole |
| | antenna | antenna | antenna | antenna |
| frequency | array | array | array | array |
| (MHz) | (dBi) | (degree) | (dBi) | (degree) |
| 698 | −13.40 | 70 | −13.40 | 64 |
| 716 | −13.80 | 68 | −13.80 | 63 |
| 728 | −14.20 | 66 | −14.20 | 62 |
| 746 | −14.70 | 63 | −14.70 | 61 |
| 824 | −9.09 | 65 | −7.52 | 59 |
| 849 | −10.70 | 61 | −9.81 | 57 |
| 869 | −10.50 | 58 | −10.10 | 55 |
| 894 | −9.75 | 56 | −9.25 | 53 |

According to FIG. 8, power of the first antenna element ANT1 in the low frequency band coupled to the antenna array of the second antenna elements ANT2_a-ANT2_d is about −25.9 dB at most. However, the high pass filters HF1, HF2 prevent power transmitting from the input terminals I2, I8 to the output terminals O1, O3, respectively. Therefore, the antenna array of the second antenna elements ANT2_a-ANT2_d directly radiates power of −25.9 dB in the low frequency band outward. Since the coupling effect is small, it can be considered that the first antenna element ANT1 simultaneously radiates power of 0 dB in the low frequency band outward. According to table 3 and table 4, the maximum gain value of the first antenna element ANT1 is 9.00 dBi, the maximum gain of the antenna array of the second antenna elements ANT2_a-ANT2_d is −7 dBi. Therefore, after considering radiation power and radiation pattern (not shown), radiation power received from the first antenna element ANT1 at the receiving terminal is about 9 dB, and radiation power received from the antenna array of the second antenna elements ANT2_a-ANT2_d at the receiving terminal is about −32.9 dB. In such a situation, the radiation power of the first antenna element ANT1 is much higher than the radiation power of the antenna array of the second antenna elements ANT2_a-ANT2_d. Therefore, in the low frequency band of Band 5, Band 12 and Band 29, the whole radiation pattern of the radio-frequency transceiver system 30 is mainly contributed by the first antenna element ANT1.

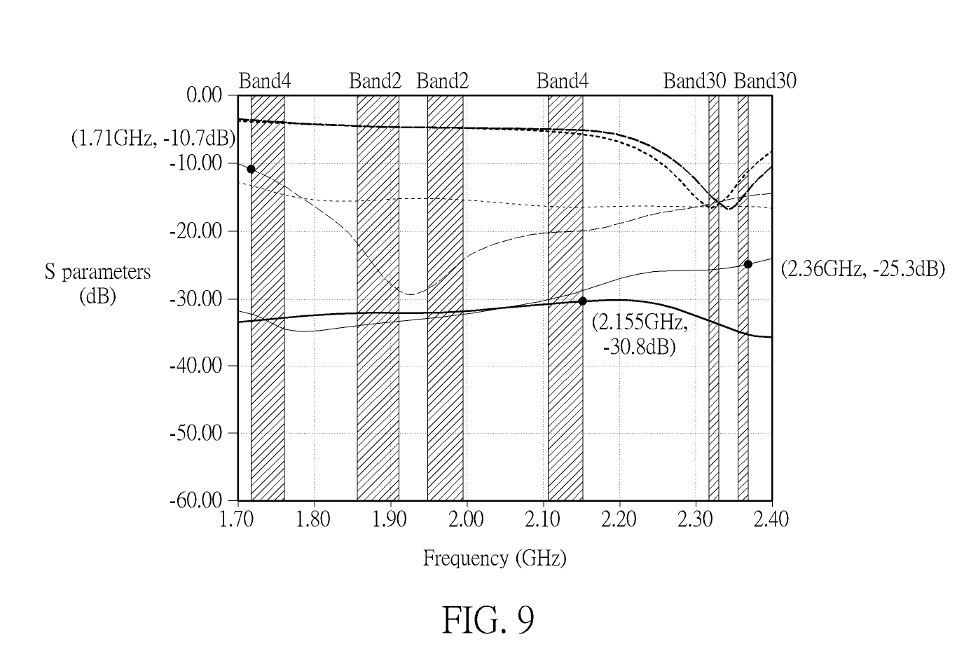

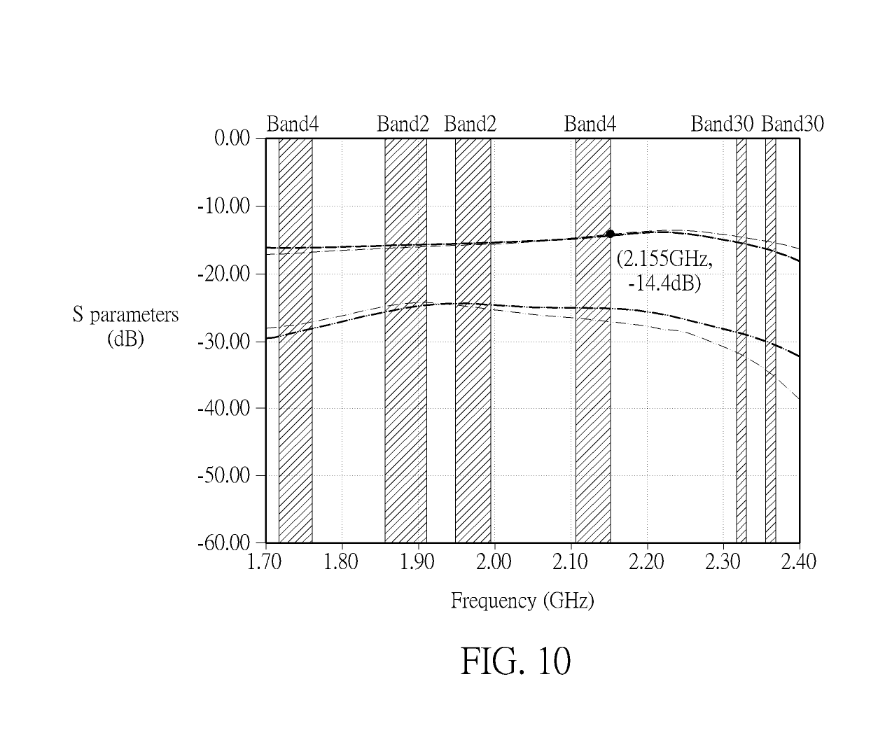

For Band 2, Band 4 and Band 30 of the high frequency band, please refer to FIG. 9, FIG. 10, table 5 and table 6, in which the length L and the width W of the radio-frequency transceiver system 30 are set to 300 mm, the height H is set to 50 mm, the longest distance L1 from the first antenna element ANT1 to the central reflective element F_C is set to 99 mm, and the longest distance L2 from the second antenna elements ANT2_a-ANT2_d to the central reflective element F_C is set to 42 mm. FIG. 9 is a schematic diagram illustrating antenna resonance simulation results of the radio-frequency transceiver system 30 operating in the high frequency band of Band 2, Band 4 and Band 30. The antenna resonance simulation result of the first two arm bowtie dipole antenna of the first antenna element ANT1 are represented by the thick long dashed line, the antenna resonance simulation result of the second two arm bowtie dipole antenna of the first antenna element ANT1 are represented by the thick short dashed line, and the antenna isolation simulation result illustrating the isolation between the first two arm bowtie dipole antenna and the second two arm bowtie dipole antenna of the first antenna element ANT1 is represented by the thick solid line. Besides, the antenna resonance simulation result of the first diamond dipole antenna (array) of the second antenna elements ANT2_a-ANT2_d are represented by the thin long dashed line, the antenna resonance simulation result for the second diamond dipole antenna (array) of the second antenna elements ANT2_a-ANT2_d are represented by the thin short dashed line, and the antenna isolation simulation result illustrating the isolation between the first diamond dipole antenna (array) and the second diamond dipole antenna (array) of the second antenna elements ANT2_a-ANT2_d is represented by the thin solid line. According to FIG. 9, within frequency bands of Band 2, Band 4 and Band 30, the return loss of the antenna array of the second antenna elements ANT2_a-ANT2_d is larger than 10.7 dB, and the isolation is greater than 25.3 dB; in comparison, the return loss of the first antenna element ANT1 operating in Band 2 and Band 4 is substantially 5 dBB, whereas the return loss of the first antenna element ANT1 operating in Band 30 is substantially 13 dB. Therefore, it is most likely for the first antenna element ANT1 to generate unnecessary radiation when operating in Band 30.

FIG. 10 is a schematic diagram illustrating the antenna isolation simulation result of the radio-frequency transceiver system 30 operating in the high frequency band of Band 2, Band 4 and Band 30, in which the isolation between the first two arm bowtie dipole antenna of the first antenna element ANT1 and the first diamond dipole antenna (array) of the second antenna elements ANT2_a-ANT2_d are represented by the thin dash-dot line, the isolation between the second two arm bowtie dipole antenna of the first antenna element ANT1 and the second diamond dipole antenna (array) of the second antenna elements ANT2_a-ANT2_d are represented by the thick dash-dot line, the isolation between the second two arm bowtie dipole antenna of the first antenna element ANT1 and the first diamond dipole antenna (array) of the second antenna elements ANT2_a-ANT2_d are represented by the thin dash-dot-dot line, and the isolation between the first two arm bowtie dipole antenna of the first antenna element ANT1 and the second diamond dipole antenna (array) of the second antenna elements ANT2_a-ANT2_d are represented by the thick dash-dot-dot line. According to FIG. 10, within high frequency bands of Band 2, Band 4 and Band 30, the antenna isolation between the first antenna element ANT1 and the antenna array of the second antenna elements ANT2_a-ANT2_d is at least 14.4 dB. Therefore, the power of the antenna array of the second antenna elements ANT2_a-ANT2_d in the high frequency band coupled to the first antenna element ANT1 is about −14.4 dB at most. Table 5 is an antenna characteristics table of the first antenna element ANT1 of the radio-frequency transceiver system 30 corresponding to different frequencies in the high frequency band of Band 2, Band 4 and Band 30. Table 6 is an antenna characteristics table of the antenna array of the second antenna elements ANT2_a-ANT2_d of the radio-frequency transceiver system 30 corresponding to different frequencies in the high frequency band of Band 2, Band 4 and Band 30. As shown in table 6, a maximum gain of the antenna array of the second antenna elements ANT2_a-ANT2_d operating in Band 2 and Band 4 is 13.6-15.9 dBi, and a maximum gain of the antenna array of the second antenna elements ANT2_a-ANT2_d operating in Band 5 is 15.2-15.8 dBi (following is illustrated as 15 dBi), so as to meet LTE wireless communication system requirements for Band 2 and Band 4 (whose maximum gain should be greater than 12 dBi) and Band 30 (whose maximum gain should be greater than 13 dBi); as shown in table 5, in comparison, although the first antenna element ANT1 is utilized for receiving and transmitting radio signals in the low frequency band, undesired resonance is generated in the high frequency band, in which the first antenna element ANT1 most likely generates undesired resonance when operating in 2.305 GHz and 2.315 GHz, and its maximum gain is about 10.1 dBi (following is illustrated as 10 dBi).

TABLE 5

| | | | | 3 dB |
|---|---|---|---|---|
| | maximum | 3 dB | maximum gain | beamwidth |
| | gain | beamwidth of | of second | of |
| | of first two | first two | two arm | second two |
| | arm bowtie | arm bowtie | bowtie | arm bowtie |
| | dipole | dipole | dipole | dipole |
| frequency | antenna | antenna | antenna | antenna |
| (MHz) | (dBi) | (degree) | (dBi) | (degree) |
| 1710 | 1.83 | 44 | −0.51 | 25 |
| 1755 | 3.10 | 45 | 0.84 | 25 |
| 1850 | 5.08 | 48 | 2.94 | 24 |
| 1910 | 6.05 | 28 | 4.09 | 24 |
| 1930 | 6.33 | 27 | 4.44 | 24 |
| 1990 | 6.94 | 24 | 5.26 | 25 |
| 2110 | 7.65 | 21 | 6.60 | 38 |
| 2155 | 8.03 | 21 | 7.40 | 53 |
| 2305 | 10.00 | 23 | 10.10 | 56 |
| 2315 | 10.00 | 23 | 10.10 | 55 |
| 2350 | 9.70 | 25 | 9.84 | 48 |
| 2360 | 9.56 | 26 | 9.69 | 45 |

TABLE 6

| | maximum | 3 dB | | 3 dB |
|---|---|---|---|---|
| | gain | beamwidth of | maximum gain | beamwidth of |
| | of first | first | of second | second |
| | diamond | diamond | diamond | diamond |
| | dipole | dipole | dipole | dipole |
| | antenna | antenna | antenna | antenna |
| frequency | array | array | array | array |
| (MHz) | (dBi) | (degree) | (dBi) | (degree) |
| 1710 | 13.6 | 34 | 14.1 | 37 |
| 1755 | 13.9 | 33 | 14.4 | 36 |
| 1850 | 14.6 | 31 | 14.9 | 34 |
| 1910 | 14.9 | 30 | 15.2 | 32 |
| 1930 | 15.1 | 30 | 15.3 | 32 |
| 1990 | 15.4 | 28 | 15.6 | 31 |
| 2110 | 15.9 | 26 | 15.9 | 28 |
| 2155 | 15.8 | 26 | 15.8 | 26 |
| 2305 | 15.4 | 22 | 15.2 | 22 |
| 2315 | 15.5 | 22 | 15.2 | 22 |
| 2350 | 15.7 | 21 | 15.5 | 22 |
| 2360 | 15.8 | 21 | 15.5 | 22 |

According to FIG. 10, power of the antenna array of the second antenna elements ANT2_a-ANT2_d in the high frequency band coupled to the first antenna element ANT1 is about −14.4 dB at most. However, the low pass filters LF1, LF2 prevent power transmitting from the input terminals I1, I7 to the output terminals O1, O3, respectively. Therefore, the first antenna element ANT1 directly radiates power of −14.4 dB in the high frequency band outward. Since the coupling effect is small, it can be considered that the antenna array of the second antenna elements ANT2_a-ANT2_d simultaneously radiate power of 0 dB in the high frequency band outward. According to table 5 and table 6, the maximum gain value of the first antenna element ANT1 is 10 dBi, the maximum gain of the antenna array of the second antenna elements ANT2_a-ANT2_d is 15 dBi. Therefore, after considering radiation power and radiation pattern, radiation power received from the first antenna element ANT1 at the receiving terminal is about −4.4 dB, and radiation power received from the antenna array of the second antenna elements ANT2_a-ANT2_d at the receiving terminal is about 15 dB. In such a situation, the radiation power of the first antenna element ANT1 is much lower than the radiation power of the antenna array of the second antenna elements ANT2_a-ANT2_d. Therefore, in the high frequency band of Band 2, Band 4 and Band 30, whole radiation pattern of the radio-frequency transceiver system 30 is mainly contributed by the antenna array of the second antenna elements ANT2_a-ANT2_d.

As can be seen from the above, interference between the first antenna element ANT1 and the antenna array of the second antenna elements ANT2_a-ANT2_d can be ignored. Besides, in the low frequency band of Band 5, Band 12 and Band 29, whole radiation pattern of the radio-frequency transceiver system 30 is mainly contributed by the first antenna element ANT1; on the other hand, in the high frequency band of Band 2, Band 4 and Band 30, whole radiation pattern of the radio-frequency transceiver system 30 is mainly contributed by the antenna array of the second antenna elements ANT2_a-ANT2_d.

Noticeably, the radio-frequency transceiver systems 10-30 are embodiments of the present invention, those skilled in the art can make alterations and modifications accordingly. For example, radiation plates (e.g. the radiation plates RP1, RP2) of the first antenna element ANT1 can include antenna structure other than the two arm bowtie dipole antenna, radiators (e.g. the radiators RT1_a, RT2_a) of the second antenna elements (e.g. the second antenna element ANT2_a) can include antenna structure other than the diamond dipole antenna (array). Besides, in order to increase frequency bands supported by the first antenna element ANT1, the radiation plate (e.g. the radiation plate RP1) of the first antenna element ANT1 can further include a third radiation arm. In comparison with the second radiation arm (e.g. the second radiation arm AR2_rp1), if the third radiation arm is utilized for receiving and transmitting radio signals of higher frequency, a length of the third radiation arm is less than a length of the second radiation arm, and the third radiation arm is disposed between the second radiation arm and the central reflective element F_C. According to requirements for gain, the radio-frequency transceiver systems 20, 30 include the four second antenna elements ANT2_a-ANT2_d, but are not limited to this. That is, the radio-frequency transceiver system can include more than four second antenna elements, to form antenna array structure. According to operating frequency band and bandwidth of the radio-frequency transceiver system, the reflective plate (e.g. the reflective plates RFP_a-RFP_d) of the second antenna elements (e.g. the second antenna elements ANT2_a) can also be removed from the antenna element.

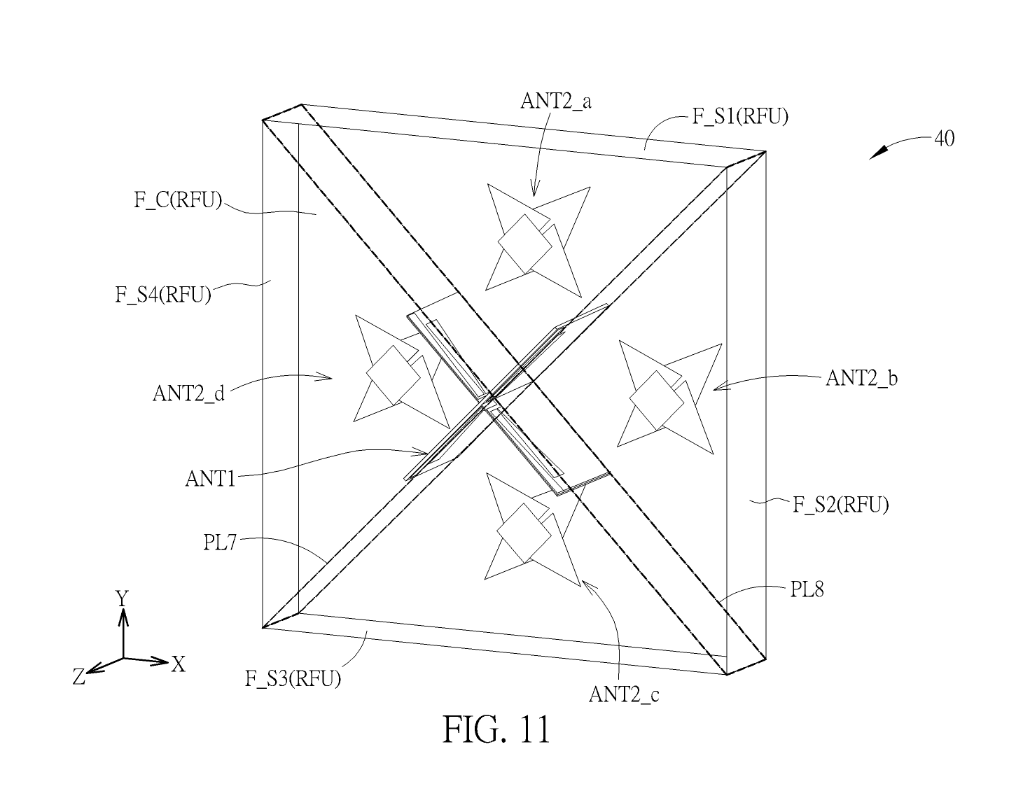

Furthermore, in the radio-frequency transceiver system 30, the first two arm bowtie dipole antenna of the first antenna element ANT1 of and the first diamond dipole antenna (array) of the second antenna elements ANT2_a-ANT2_d are both vertically polarized, the second two arm bowtie dipole antenna of the first antenna element ANT1 and the second diamond dipole antenna (array) of the second antenna elements ANT2_a-ANT2_d are both horizontally polarized, but are not limited to this. The radio-frequency transceiver system can also receive and transmit radio signals via a 45-degree slant polarized antenna and a 135-degree slant polarized antenna. For example, please refer to FIG. 11, which is a schematic diagram of a radio-frequency transceiver system 40 according to an embodiment of the present invention. The structure of the radio-frequency transceiver system 40 is similar with the structure of the radio-frequency transceiver system 30, and thus the same elements are denoted by the same symbols. Different from the radio-frequency transceiver system 30, the first antenna element ANT1 and the antenna array of the second antenna elements ANT2_a-ANT2_d of the radio-frequency transceiver system 40 are substantially symmetric with respect to planes PL7, PL8, and the diagonal of the central reflective element F_C of the reflective unit RFU is located in the planes PL7, PL8. Therefore, the first two arm bowtie dipole antenna of the first antenna element ANT1 and the first diamond dipole antenna (array) of the second antenna elements ANT2_a-ANT2_d are both 135-degree slant polarized, the second two arm bowtie dipole antenna of the first antenna element ANT1 and the second diamond dipole antenna (array) of the second antenna elements ANT2_a-ANT2_d are both 45-degree slant polarized.

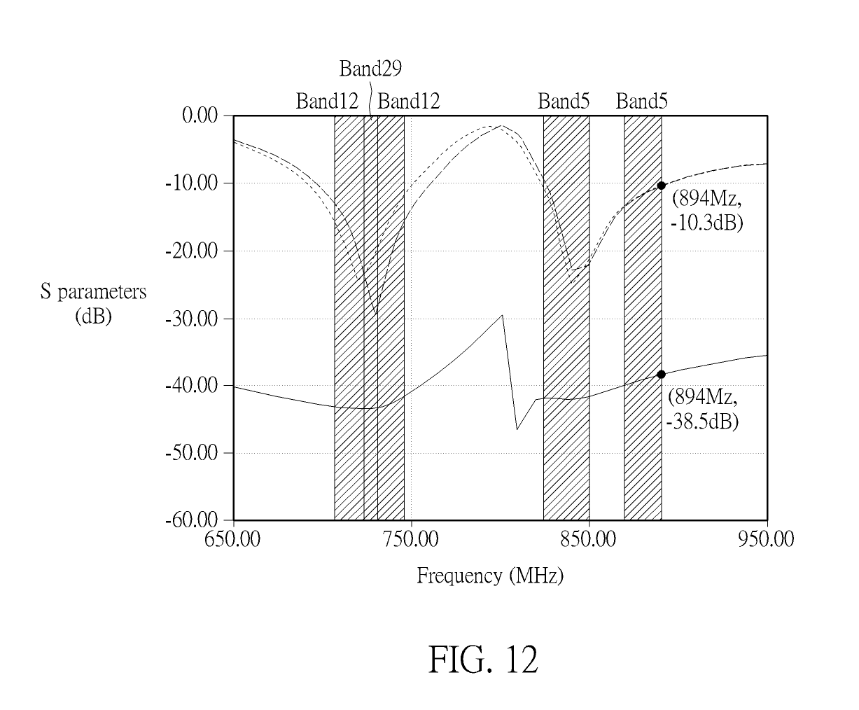

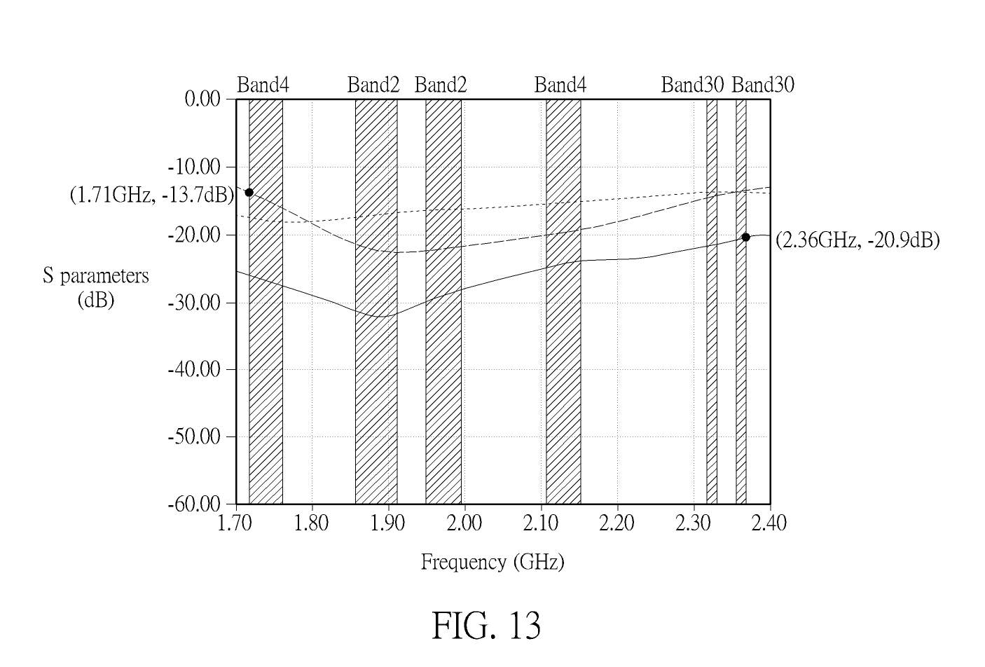

Simulation and measurement may be employed to determine whether resonant characteristics and radiation pattern of the radio-frequency transceiver system 40 meets system requirements. Please refer to FIGS. 12, 13, in which a length L and a width W of the radio-frequency transceiver system 40 are set to 300 mm, a height H is set to 50 mm, a longest distance L1 from the first antenna element ANT1 to the central reflective element F_C is set to 99 mm, and a longest distance L2 from the second antenna elements ANT2_a-ANT2_d to the central reflective element F_C is set to 42 mm. FIGS. 12, 13 are schematic diagrams illustrating antenna resonance simulation results of the radio-frequency transceiver system 40 operating in the low frequency band of Band 5, Band 12 and Band 29, and in the high frequency band of Band 2, Band 4 and Band 30, respectively. In FIG. 12, the antenna resonance simulation result of the first two arm bowtie dipole antenna formed by the radiation plates RP1, RP2 are represented by the long dashed line, the antenna resonance simulation result for the second two arm bowtie dipole antenna formed by the radiation plates RP3, RP4 are represented by the short dashed line, and the antenna isolation simulation result illustrating the isolation between the first two arm bowtie dipole antenna and the second two arm bowtie dipole antenna is represented by the solid line. According to FIG. 12, within frequency bands of Band 5, Band 12 and Band 29, the return loss of the radio-frequency transceiver system 40 is larger than 10.3 dB, and the isolation is greater than 38.5 dB, which meet the LTE wireless communication system requirements of having the return loss larger than 10 dB and the isolation greater than 20 dB. In FIG. 13, the antenna resonance simulation result of the first diamond dipole antenna (array) formed by the second antenna elements ANT2_a-ANT2_d are represented by the long dashed line, the antenna resonance simulation result of the second diamond dipole antenna (array) formed by the second antenna elements ANT2_a-ANT2_d are represented by the short dashed line, and the antenna isolation simulation result illustrating the isolation between the first diamond dipole antenna (array) and the second diamond dipole antenna (array) of the second antenna elements ANT2_a-ANT2_d is represented by the solid line. According to FIG. 13, within frequency bands of Band 2, Band 4 and Band 30, the return loss of the radio-frequency transceiver system 40 is larger than 13.7 dB, and the isolation is greater than 20.9 dB.

In prior arts, multiple antennas are implemented in order to correspond to different frequency bands, one of the major drawbacks is that electronic products of which the antennas are implemented in are not easily minimized. Additionally, multiplexers or diplexers are used, thereby increasing additional power loss.

In comparison, the radio-frequency transceiver system of the present invention provides two independent antennas via the first antenna element and the second antenna elements, to receive and transmit radio signals of multiple frequency bands. Planes which the first antenna element and the second antenna elements are respectively disposed are perpendicular to each other, such that space can be fully utilized to minimize the size. Besides, interference between the first antenna element and the second antenna elements between can be ignored. Therefore, for the low frequency band or the high frequency band, the whole radiation pattern of the radio-frequency transceiver system is mainly contributed by the first antenna element or the second antenna elements, respectively. Besides, the radio-frequency transceiver system of the present invention can further reduce the number of diplexer or multiplexer in use, thereby avoid additional energy loss.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radio-frequency transceiver system, comprising:
a first plane;
a second plane, perpendicular to the first plane;
a third plane, perpendicular to the first plane and the second plane;
a first antenna element, comprising:
a first radiation plate, disposed on the first plane;
a second radiation plate, disposed on the first plane;
a third radiation plate, disposed on the second plane; and
a fourth radiation plate, disposed on the second plane; and
a plurality of second antenna elements,
wherein the plurality of second antenna elements form an antenna array structure, wherein the antenna array structure is symmetric with respect to the first plane and the second plane, wherein each of the second antenna elements is dual-polarized dipole antenna.

2. The radio-frequency transceiver system of claim 1, wherein the first radiation plate and the second radiation plate are symmetric with respect to the second plane, and the third radiation plate and the fourth radiation plate are symmetric with respect to the first plane.

3. The radio-frequency transceiver system of claim 1 further comprising a reflective unit, wherein the reflective unit comprises:
a central reflective element, disposed parallel to the third plane; and
a plurality of peripheral reflective elements, disposed around the central reflective element;
wherein the reflective unit is symmetric with respect to the first plane and the second plane.

4. The radio-frequency transceiver system of claim 3, wherein each of the plurality of second antenna elements further comprises:
a first radiator, disposed on the third plane;
a second radiator, disposed on the third plane, wherein the first radiator and the second radiator are symmetric with respect to a fourth plane;
a third radiator, disposed on a fifth plane, wherein the fifth plane is parallel to the third plane and is located between the third plane and the central reflective element;
a fourth radiator, disposed on the fifth plane, wherein the third radiator and the fourth radiator are symmetric with respect to a sixth plane; and
a reflective plate, disposed above the first radiator and the second radiator, wherein a shape of the reflective plate is symmetric.

5. The radio-frequency transceiver system of claim 4, wherein the first plane is parallel to or perpendicular to the fourth plane.

6. The radio-frequency transceiver system of claim 4, wherein the reflective plate is a regular polygon or a circle, and a number of vertexes of the regular polygon of a multiple of 4.

7. The radio-frequency transceiver system of claim 4, wherein the first radiator and the second radiator form a diamond dipole antenna structure, and the third radiator and the fourth radiator form another diamond dipole antenna structure.

8. The radio-frequency transceiver system of claim 1, wherein the first radiation plate and the second radiation plate form a bowtie dipole antenna structure, and the third radiation plate and the fourth radiation plate form another bowtie dipole antenna structure.

9. The radio-frequency transceiver system of claim 1, wherein each of the first radiation plate, the second radiation plate, the third radiation plate and the fourth radiation plate comprises:
a first radiation arm; and
a second radiation arm, disposed between the first radiation arm and the central reflective element, wherein a second length of the second radiation arm is less than a first length of the first radiation arm.

10. The radio-frequency transceiver system of claim 1, wherein a number of the plurality of second antenna elements is a multiple of 4.

11. The radio-frequency transceiver system of claim 1 further comprising a single diplexer, for integrating first frequency band signals received and transmitted by the first antenna element and second frequency band signal received and transmitted by the plurality of second antenna elements.
